(19) United States
(12) Patent Application Publication
(10) Pub. No.: US 2014/0108121 A1
(43) Pub. Date: Apr. 17, 2014

(54) Pay Per Appointment Advertising

(71) Applicants: Kenneth S. Norton, San Carlos, CA (US); Heather Folsom, Palo Alto, CA (US); Mikhail Leder, Brooklyn, NY (US); Daniel Thomasset, Omaha, NE (US); Jake Chambers, Papillion, NE (US)

(72) Inventors: Kenneth S. Norton, San Carlos, CA (US); Heather Folsom, Palo Alto, CA (US); Mikhail Leder, Brooklyn, NY (US); Daniel Thomasset, Omaha, NE (US); Jake Chambers, Papillion, NE (US)

(21) Appl. No.: 12/945,706

(22) Filed: Nov. 12, 2010

(51) Int. Cl. G06Q 10/00; G06Q 30/00

(52) U.S. Cl. 705/14.35; 705/1.1; 705/34

(57) ABSTRACT

In methods and systems for allowing a user to book an appointment with a service provider, and for charging the service provider a fee for a successfully booked appointment, a user provides a search request via a client computer. In response, a calendar system provides search results including a link corresponding to a service provider. Upon user selection of the link corresponding to the service provider, the calendar system provides a calendar view showing available time slots of the service provider. The user selects an appointment time and available service, which initiates an appointment request to schedule an appointment with the service provider. Upon determining that the appointment request can be accepted, the calendar system books the appointment. Then the calendar system charges the service provider a pre-arranged fee for the booked appointment. In some embodiments the calendar system also collects payments from the user for the services provided.

### TECHNICAL FIELD

The disclosed embodiments relate generally to electronic calendars. More particularly, the disclosed embodiments relate to methods and systems for allowing a user to book an appointment with a service provider, and charging the service provider a fee for a successfully booked appointment.

### BACKGROUND

Users often need to make appointments with service providers such as plumbers, massage therapists, doctors etc. Similarly, users may wish to sign up for a class offered by a service provider, or may wish to rent equipment from a service provider. In many instances, in order to make an appointment, the user must call the service provider to schedule the appointment. The appointments generally must be scheduled during work hours, requiring the user to take time out of his or her day to make the call. Still, the service provider may be unavailable to answer the phone, in which case the user may leave a message or try a different service provider. Furthermore, the user has no way of knowing the service provider's schedule to even know if the service provider has available appointment times that are required by the user.

Service providers wish to reach potential customers and expand their businesses. To do so, service providers may buy advertisements in newspapers, yellow pages, or on the internet. However, this is an upfront cost that has no direct measurable correlation to appointments booked. Furthermore, the amount the service provider spends on advertising does not scale in correlation to the appointments booked. Furthermore, there is no direct relationship between the amount of available time the service provider has to offer and the service provider's advertising expenditures. For example, the service provider may be very busy, and ends up wasting time answering the phone for appointment requests he cannot accept. Alternatively, the service provider may have several timeslots that are currently un-filled which the service provider would be willing to pay an advertising premium to fill.

Therefore, there is a need to overcome these problems for both users and service providers.

### SUMMARY

The disclosed embodiments overcome the limitations and disadvantages described above by providing methods and systems for booking appointments.

One aspect involves a computer-implemented method performed on a server system having one or more processors and memory storing one or more programs which when executed by the one or more processors cause performance of the following method. A calendar view showing available time slots of a service provider is provided to a client computer associated with a user who is distinct from the service provider. An appointment request to schedule an appointment with the service provider is received from the client computer. Upon determining that the appointment request can be accepted, the appointment is booked. After booking the appointment, the service provider is charged a pre-arranged fee for the booked appointment.

Another aspect is a server system comprising one or more processors (e.g., CPU(s)), for executing programs and also includes memory storing the programs to be executed by the one or more processors. The programs include instructions to perform the following. A calendar view showing available time slots of a service provider is provided to a client computer associated with a user who is distinct from the service provider. An appointment request to schedule an appointment with the service provider is received from the client computer. Upon determining that the appointment request can be accepted, the appointment is booked. After booking the appointment, the service provider is charged a pre-arranged fee for the booked appointment.

Yet another aspect involves a computer readable storage medium storing one or more programs configured for execution by a server system. The programs include instructions to perform the following. A calendar view showing available time slots of a service provider is provided to a client computer associated with a user who is distinct from the service provider. An appointment request to schedule an appointment with the service provider is received from the client computer. Upon determining that the appointment request can be accepted, the appointment is booked. After booking the appointment, the service provider is charged a pre-arranged fee for the booked appointment.

Thus, these methods, systems, and computer readable storage mediums provide new, less cumbersome, more efficient ways to book appointments between a service provider and a user.

### BRIEF DESCRIPTION OF THE DRAWINGS

For a better understanding of the aforementioned aspects as well as additional aspects and embodiments thereof, reference should be made to the Description of Embodiments below, in conjunction with the following drawings.

FIG. 1 is a block diagram illustrating an exemplary distributed computer system, in accordance with some embodiments.

FIG. 2 is a flowchart representing the interaction of the client, the calendar system, and the service provider, in accordance with some embodiments.

FIG. 3 is a block diagram illustrating an exemplary calendar server system, in accordance with some embodiments.

FIG. 4A is a block diagram illustrating an exemplary client system, in accordance with some embodiments. FIG. 4B is a block diagram illustrating an exemplary service provider system, in accordance with some embodiments.

FIG. 5 is a block diagram illustrating an exemplary calendar database and an exemplary bookable appointment record in the calendar database, in accordance with some embodiments.

FIG. 6 is a block diagram illustrating an exemplary service provider database and an exemplary service provider record in the service provider database, in accordance with some embodiments.

FIG. 7 is a block diagram illustrating an exemplary payment database and a payment record in the payment database, in accordance with some embodiments.

FIGS. 8A-8C are flowcharts representing a method of booking an appointment, in accordance with some embodiments.

FIGS. 9A-9B are schematic screen shots of exemplary graphical user interfaces for booking appointments in accordance with some embodiments.

Like reference numerals refer to corresponding parts throughout the drawings.

### DESCRIPTION OF EMBODIMENTS

Reference will now be made in detail to embodiments, examples of which are illustrated in the accompanying drawings. In the following detailed description, numerous specific details are set forth in order to provide a thorough understanding. However, it will be apparent to one of ordinary skill in the art that embodiments may be practiced without these specific details. In other instances, well-known methods, procedures, components, circuits, and networks have not been described in detail so as not to unnecessarily obscure aspects of the embodiments.

It will also be understood that, although the terms first, second, etc. may be used herein to describe various elements, these elements should not be limited by these terms. These terms are only used to distinguish one element from another. For example, a first appointment could be termed a second appointment, and, similarly, a second appointment could be termed a first appointment, without departing from the scope of the present invention. The first appointment and the second appointment are both appointments, but they are not the same appointment.

The terminology used in the description of the invention herein is for the purpose of describing particular embodiments only and is not intended to be limiting of the invention. As used in the description of the invention and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” may be construed to mean “when” or “upon” or “in response to determining” or “in response to detecting,” depending on the context. Similarly, the phrase “if it is determined” or “if [a stated condition or event] is detected” may be construed to mean “upon determining” or “in response to determining” or “upon detecting (the stated condition or event)” or “in response to detecting (the stated condition or event),” depending on the context.

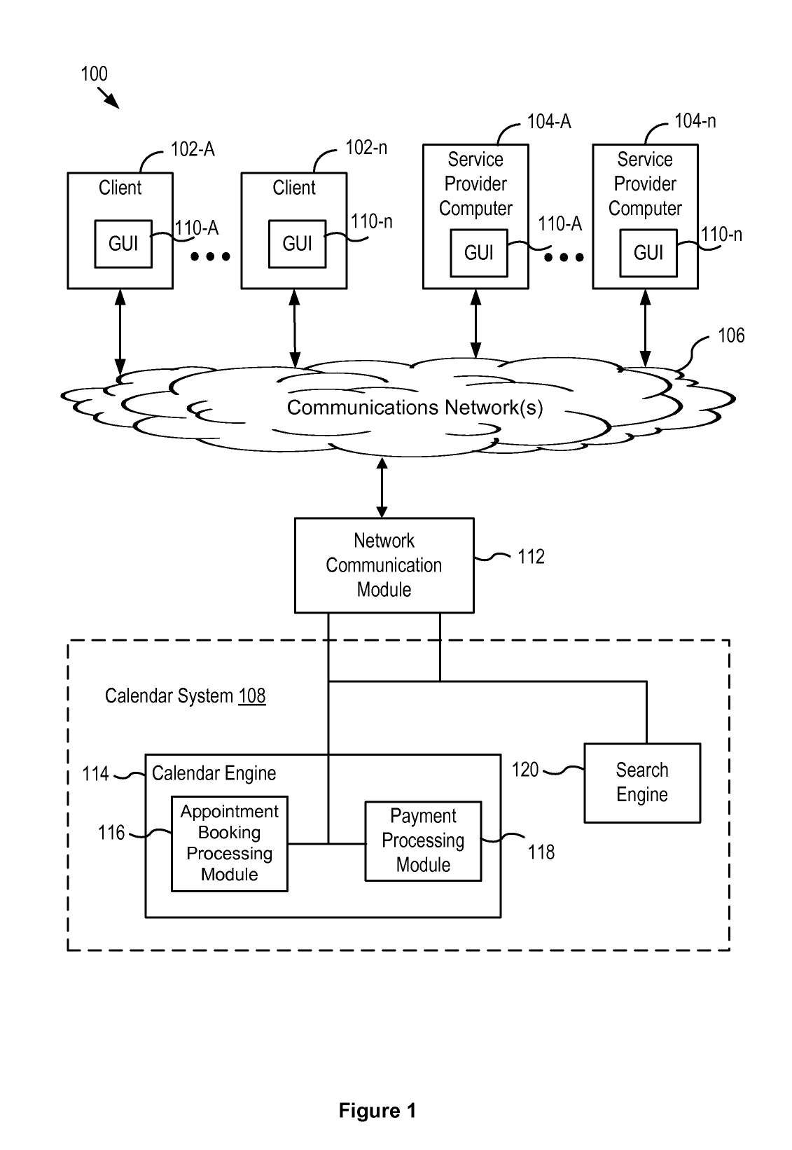

FIG. 1 is a block diagram illustrating an exemplary distributed computer system 100, according to certain embodiments of the invention. System 100 may include one or more client computers 102, service provider computers 104, a communications network 106, and a calendar system 108.

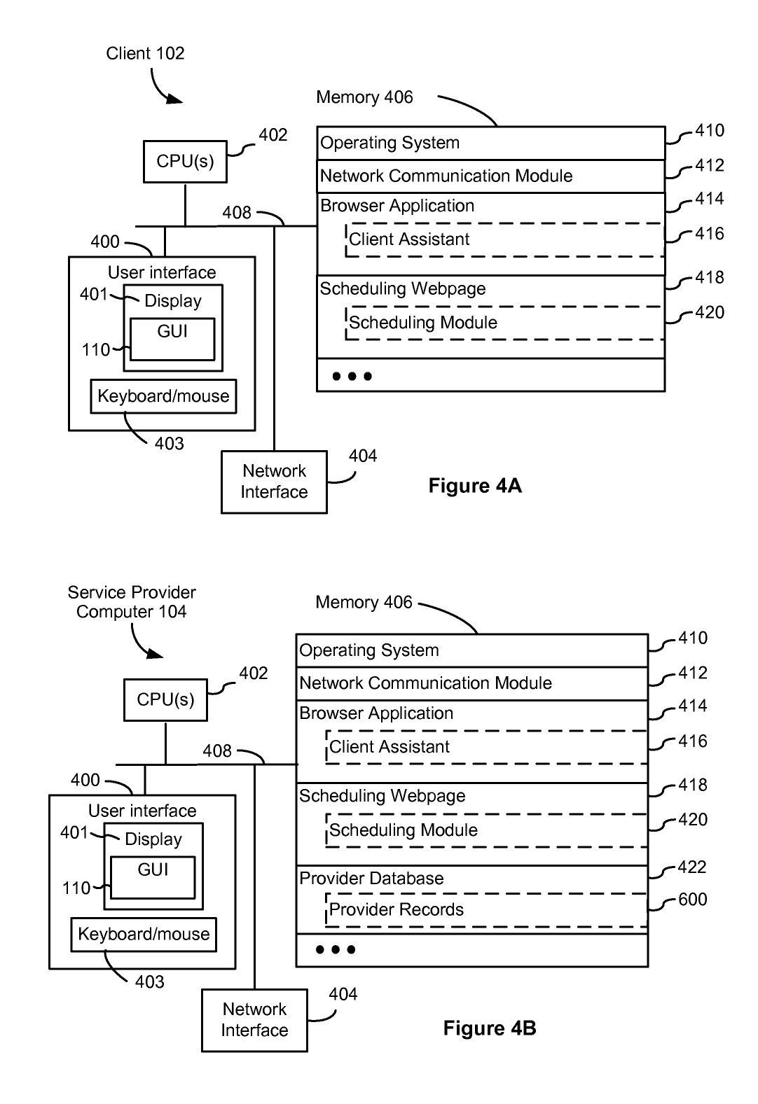

Client computers 102 can be any of a number of computing devices (e.g., Internet kiosk, personal digital assistant, cell phone, gaming device, desktop computer, laptop computer, handheld computer, or combinations thereof). Client computer(s) 102 are also referred to herein as client(s). The clients 102 are described in greater detail below with reference to FIG. 4A. A respective client 102 includes a graphical user interface (GUI) 110. As described in more detail below, GUI 110 is used to display a portion of a service provider's calendar and the search interface for scheduling calendar events. Clients 102 are connected to calendar system 108 via communications network 106.

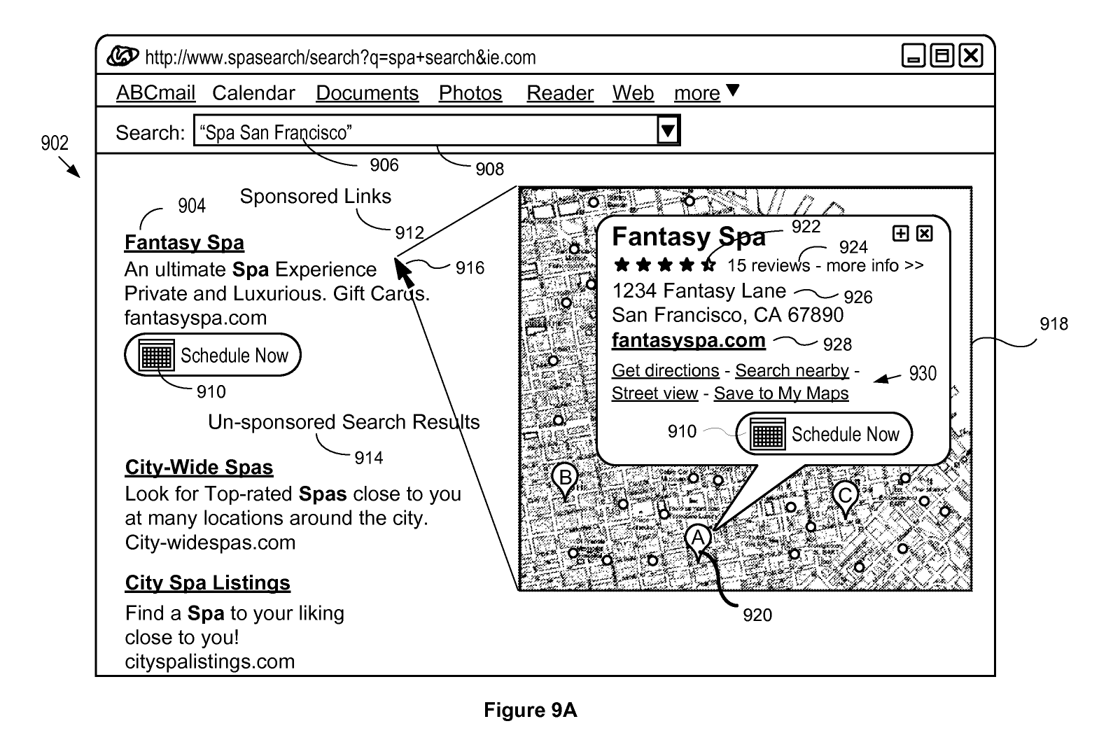

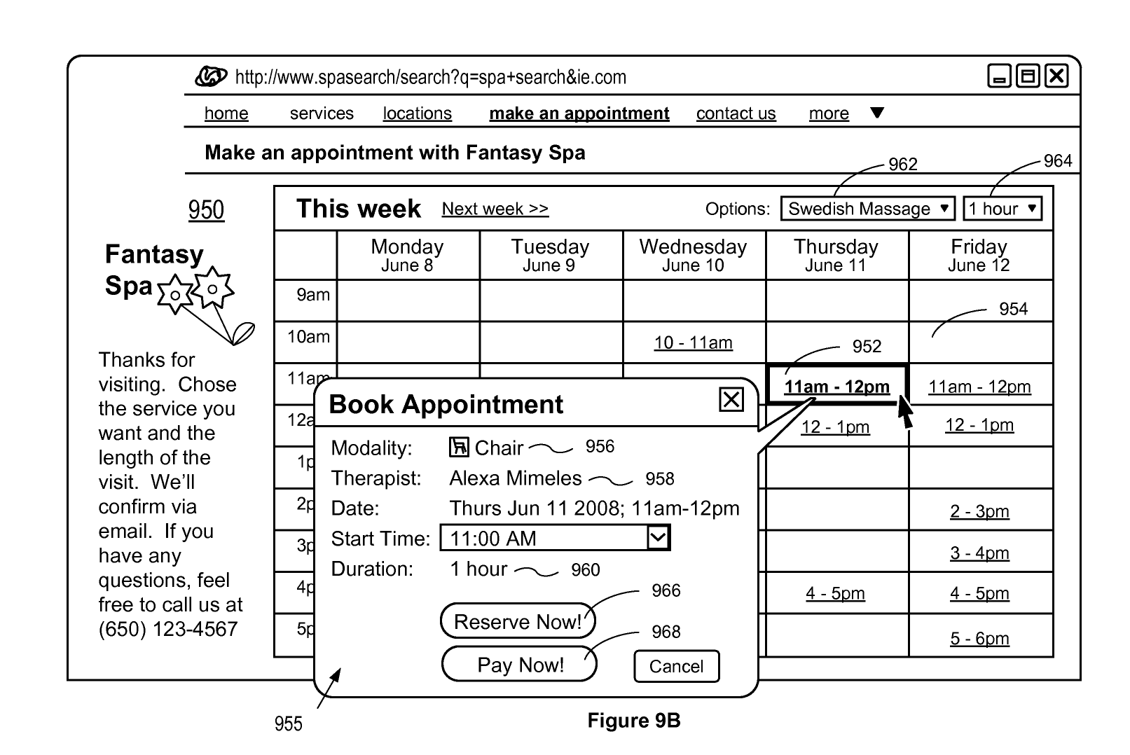

Service provider computers 104 (also sometimes called service provider systems, as some service provider systems comprise multiple computers) can likewise be any of a number of computing devices (e.g., Internet kiosk, personal digital assistant, cell phone, gaming device, desktop computer, laptop computer, handheld computer, or combinations thereof). Service provider computers 104 are described in greater detail below with reference to FIG. 4B. A respective service provider computer 104 includes a graphical user interface (GUI) 110. As described in more detail below, GUI 110 (e.g., as shown in FIGS. 9A-9B) is used to display a portion of a service provider's calendar and the interface for providing calendar information, a service fee schedule, criteria for accepting appointments, and bids or bid schedules. Service provider computer 104 is connected to calendar system 108 via communications network 106.

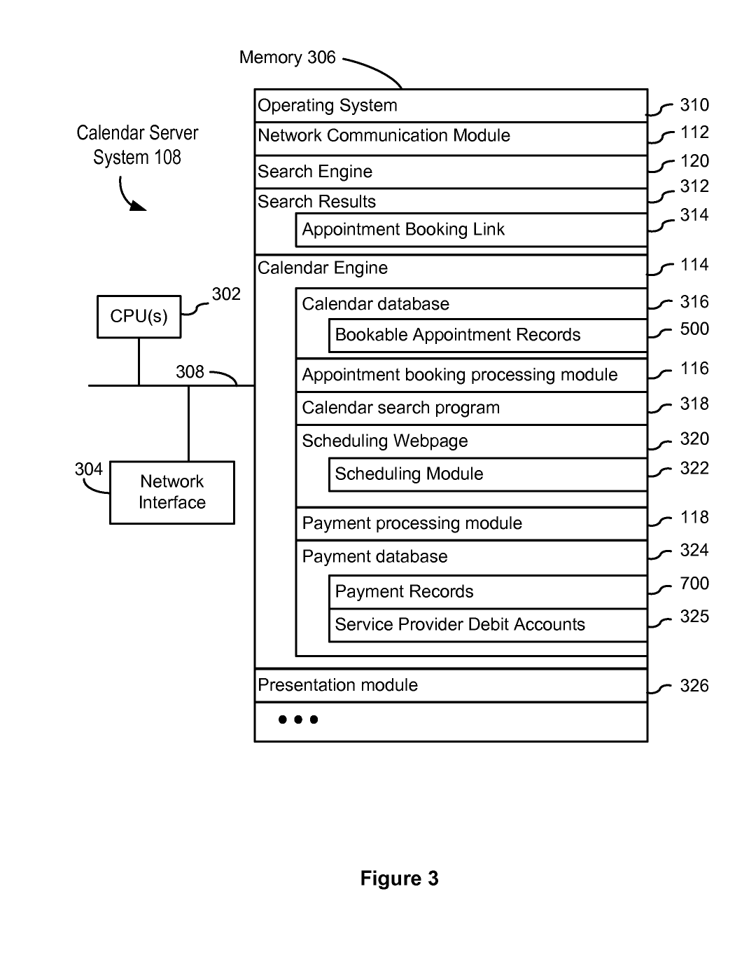

Calendar system 108 includes one or more servers, connected to the communications network 106 via network communication module 112. The calendar system includes a calendar engine 114, which includes an appointment booking processing module 116 and a payment processing module 118. Calendar system 108 also includes a search engine 120, which may be on the same or a separate server from calendar engine 114. The network communications module 112 connects calendar system 108 to communication network 106 and enables communications with clients 102 and service provider computers 104. Internal communications between the components of calendar system 108 may also be handled by network communication module 112, by a local area network, by internal communication busses, or by any other appropriate mechanism or combination of mechanisms. Calendar system 108 is described in greater detail below with respect to FIG. 3.

In the cases where the calendar system includes multiple servers, each server is coupled to communications network 106 via a network communication module 112. The communications network 106 may be the Internet, but may also be any local area network (LAN), wide area network (WAN), metropolitan area network, or a combination of such networks. In some embodiments, calendar system 108 is a web server that manages electronic calendars using appropriate communication protocols.

As discussed in more detail below, calendar system 108 transmits a service provider's calendar information to a respective client 102 for assisting the client in booking an appointment with a service provider during an available timeslot. Optionally, calendar system 108 is part of a larger calendaring service provided to a community of users (e.g. the employees of a company, members of an organization or group, the users of a facility, etc.) In some embodiments, fewer and/or additional modules, functions or databases are included in calendar system 108. The modules shown in calendar system 108 represent functions performed in certain embodiments.

Notwithstanding the discrete blocks in FIG. 1, the figure is intended to be a functional description of some embodiments rather than a structural description of functional elements. An actual implementation might have the functional elements grouped or split among various components. For example, in some embodiments, search engine 120 may be stored on a separate server. Similarly, separate servers may handle the appointment processing and the payment processing. The actual number of servers used to implement a calendar system 108 and how features are allocated among them will vary from one implementation to another, and may depend in part on the amount of data traffic that the system must handle during peak usage periods as well as during average usage periods, and the amount of data stored by the calendar system. Moreover, one or more of the blocks in FIG. 1 may be implemented on one or more servers designed to provide the described functionality. Although the description herein refers to certain features implemented in clients 102, service provider computers 104, and calendar system 108, embodiments are not limited to such distinctions. For example, features described herein as being part of calendar system 108 can be implemented in whole or in part at service provider computer 104, and vice versa.

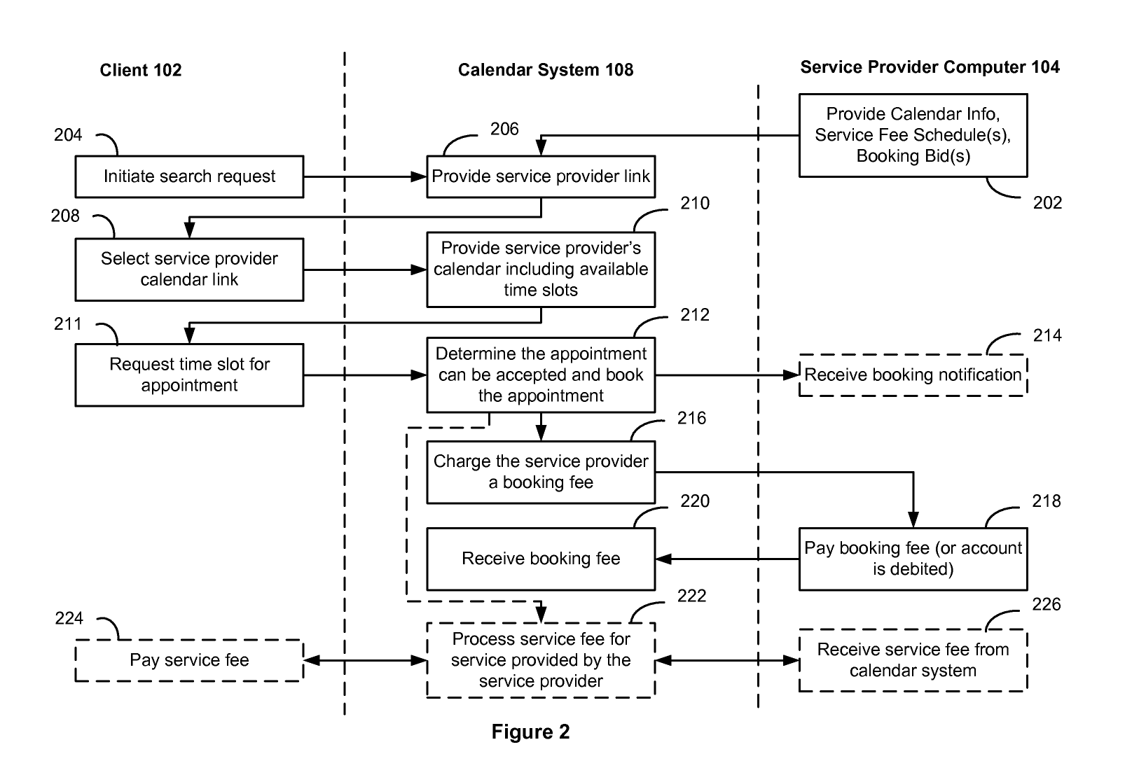

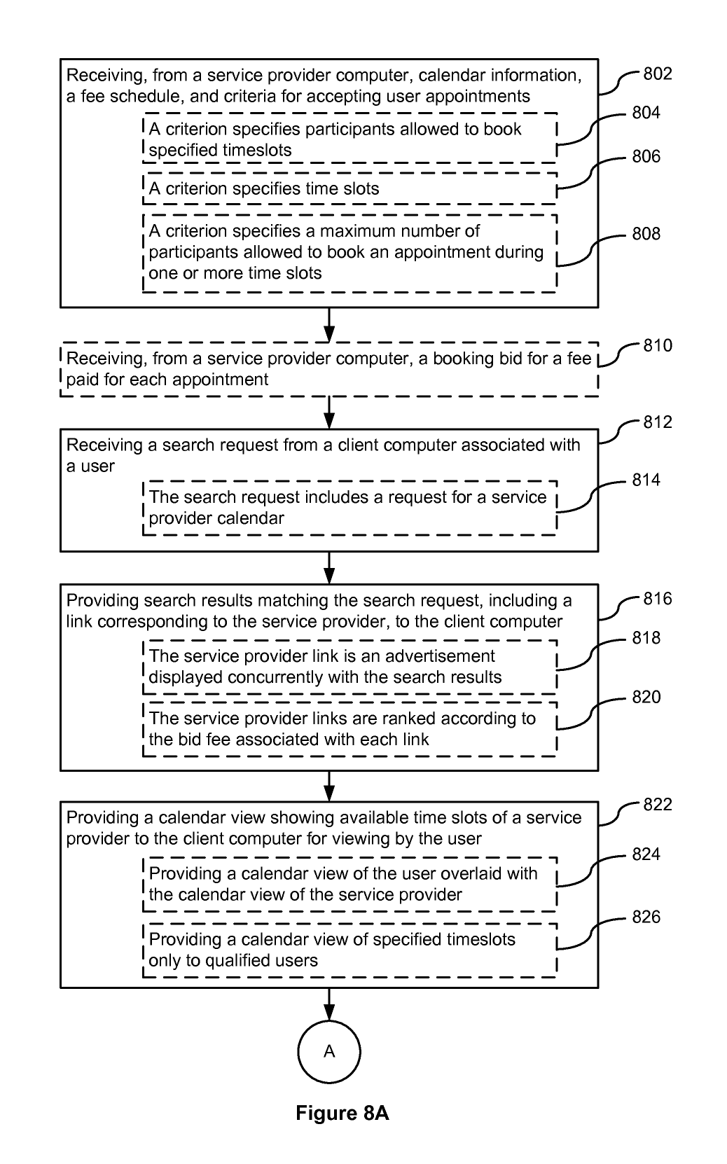

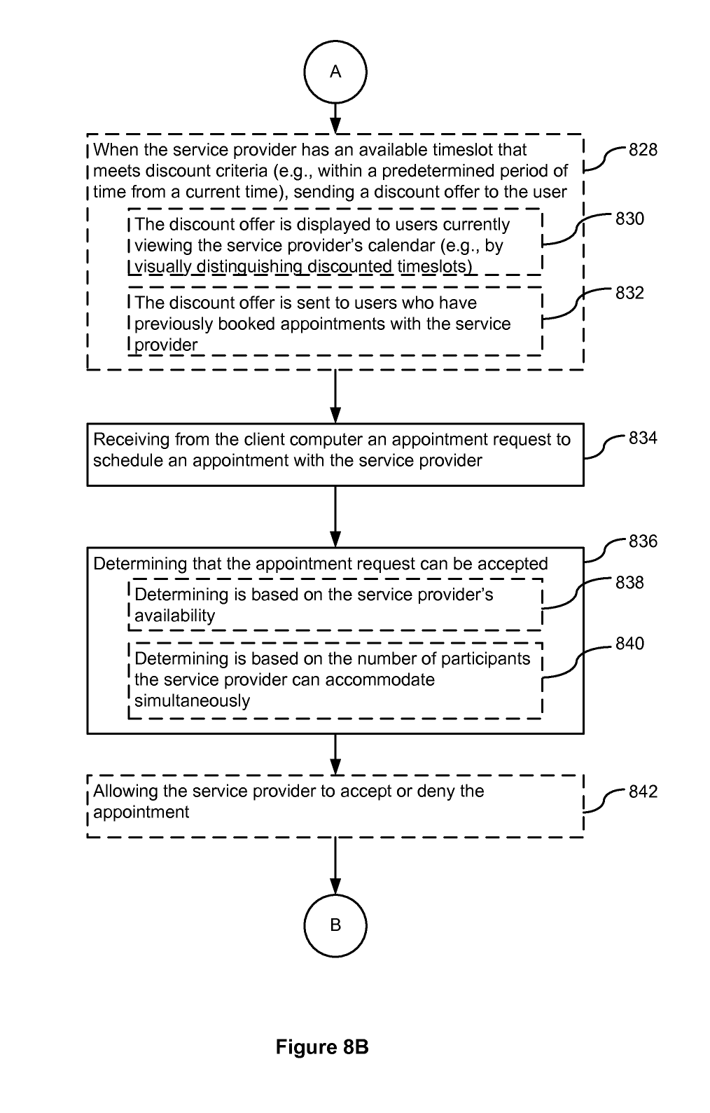

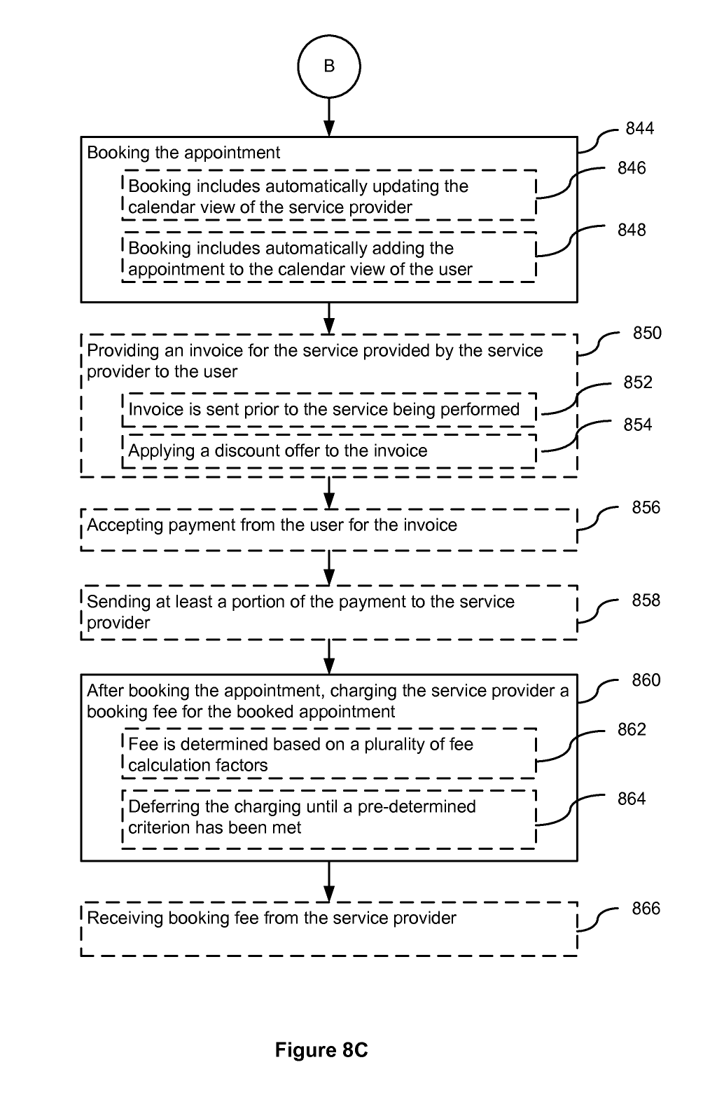

FIG. 2 is a flowchart representing the interaction of client 102, calendar system 108, and service provider computer 104, in accordance with some embodiments. The details of this interaction will be discussed with respect to FIGS. 8A-8C.

In order to allow users to book appointments through calendar system 108, the service provider sets up an account with calendar system 108. Service provider computer 104 provides calendar information, a service fee schedule, and one or more booking bids (202) to calendar system 108. In some embodiments, calendar system 108 uses the booking bids to rank service providers in response to search queries: service providers that make high booking bids appear higher in the search results than service providers that make lower booking bids. Once the account is set up, the service provider's calendar will be available for display on client 102. In some embodiments, a user will initiate a search request (204). For example, client 102 may submit the search query “spa San Francisco.” The search request will be processed, and a list of search results will be displayed. At least one of the search results will include the service provider's link (206). The link may include an icon indicating that the service provider's calendar is available. If the user is interested in the service provider, he will select the link (208). Then the user will be provided with the service provider's calendar including timeslots in which the service provider is available to accept appointments (210). If the user wishes to book an appointment during one of the available time slots, the user requests the time slot for an appointment (211). In some embodiments, the user will also select a particular service from a list of available services available in that timeslot. Upon determining that the appointment request can be accepted, the calendar system will book the appointment (212). The appointment will be updated in the service provider's calendar. In some embodiments, the service provider will receive a booking notification (214). Then the service provider will be charged a booking fee for the booked appointment (216). In some embodiments, the booking fee is a pre-arranged fee (or fee calculation) provided by the service provider as the booking bid at step 202. Alternatively, calendar system 108 specifies the booking fee. The service provider pays the fee (or the fee is debited from the service provider's account) (218). Either way, calendar system 108 receives the booking fee for the successfully booked appointment between the user/client 102 and the service provider/service provider computer 104 (220).

One of the benefits of this arrangement is that the user can book appointments outside of normal business hours. Since he does not need to call the service provider to book an appointment, the appointments can be booked at any time that is convenient for the user. Another advantage for the user is that additional information may be available to him at the time of booking. For example, the search results may include a map indicating the locations of all the spas in San Francisco; as such, the user can select a spa at a convenient location for him (e.g., close to his house, office, gym etc.) The search results may also provide reviews or star ratings for the service providers. The user can filter providers (e.g., by ratings and reviews or by available timeslots etc.) before booking an appointment.

Furthermore, there are several benefits for the service provider. Under this automated appointment booking system, the service provider does not need to spend time answering the phone and keeping his appointment calendar up to date. Rather, the service provider can concentrate on serving his current customer and let the calendar fill itself. From an advertising perspective, the service provider only pays for appointments booked. In other words, there is a direct correlation between booked appointments and advertising dollars spent by the service provider. If the service provider has no available timeslots, he will not pay any advertising dollars under this system. As will be explained in greater detail below, additional options may be available to the service provider. For example, in some embodiments, calendar system 108 will send appointment reminders to the user, reducing the “no show” rates without requiring the service provider to take the time to call or send physical or electronic reminders. Also, in some embodiments, calendar system 108 provides discount options to users. For example, the service provider may set up his fee schedule to give a specified discount for appointments booked within a specified time period (e.g., 20% discounts for any “same day” booked appointments), improving the chances that the service provider will fill an otherwise empty timeslot.

In some embodiments, calendar system 108 also assists in processing the service fee for the service provided by the service provider (222). Calendar system 108 sends an invoice to client 102 at some predetermined time, for example, at the time of booking, at the time of the appointment, or after appointment. Client 102 pays the service fee to calendar system 108 (224). In some embodiments, the user of client 102 has the option of including a tip or gratuity in the service payment. Then calendar system 108 provides at least a portion of the service fee to the service provider (226). In some instances, a transaction cost is deducted from the service fee. Alternatively, the service fees are deposited in a debit account for the service provider (e.g., debit account 325, FIG. 3), to be applied against future booking fees that calendar system 108 charges to the service provider. The service provider receives the service fees by periodically making withdrawals from the debit account at his own discretion.

FIG. 3 is a block diagram illustrating an exemplary calendar server system 108, in accordance with some embodiments. Calendar system 108 includes one or more processing units (CPUs) 302, one or more network or other communications interfaces 304, memory 306, and one or more communication buses 308 for interconnecting these components. Communication buses 308 may include circuitry (sometimes called a chipset) that interconnects and controls communications between system components. Calendar system 108 optionally includes a user interface (not shown) (e.g., a user interface having a display device, a keyboard, and a mouse or other pointing device), but more typically calendar system 108 is controlled from and accessed by various external systems (e.g., client computers 102 and service provider computers 104, FIG. 1).

Memory 306 of calendar system 108 includes high-speed random access memory, such as DRAM, SRAM, DDR RAM or other random access solid state memory devices; and may include non-volatile memory, such as one or more magnetic disk storage devices, optical disk storage devices, flash memory devices, or other non-volatile solid state storage devices. Memory 306 may optionally include one or more storage devices remotely located from the CPU(s) 302. Memory 306, or alternately the non-volatile memory device(s) within memory 306, comprises a non-transitory computer readable storage medium. In some embodiments, memory 306 or the non-transitory computer readable storage medium of memory 306 stores the following programs, modules and data structures, or a subset thereof:
Operating System 310 that includes procedures for handling various basic system services and for performing hardware dependent tasks;
Network Communication Module (or instructions) 112 that is used for connecting calendar system 108 to other computers (e.g., clients 102 and service provider computers 104) via the one or more communications Network Interfaces 304 (wired or wireless) and one or more communications networks 106 (FIG. 1), such as the Internet, other wide area networks, local area networks, metropolitan area networks, and so on;
Search Engine 120 that receives queries from client 102 and processes them;
Search Results 312 produced by search engine 120, which include at least one appointment booking link 314 corresponding to a service provider that allows a user to view the service provider's available timeslots;
Calendar Engine 114 that handles processes associated with booking an appointment;
Scheduling Webpage 320, which displays the calendar view showing available time slots of a service provider, and displays the booked appointment;
Scheduling Module 322, included in scheduling webpage 320, which processes the information to be displayed in scheduling webpage 320;
Payment Processing Module 118, which handles processes associated with appointment payments, including charging the service provider a booking fee, collecting the booking fee (e.g., by direct payment or debit), and, in some embodiments, processing the service fee for the service provided by the service provider;
Payment Database 324, which payment processing module 118 accesses to look up booking fee amounts and service fee schedules for the service provider; and
Presentation module 220 that formats the results from Calendar Engine 114 for display.

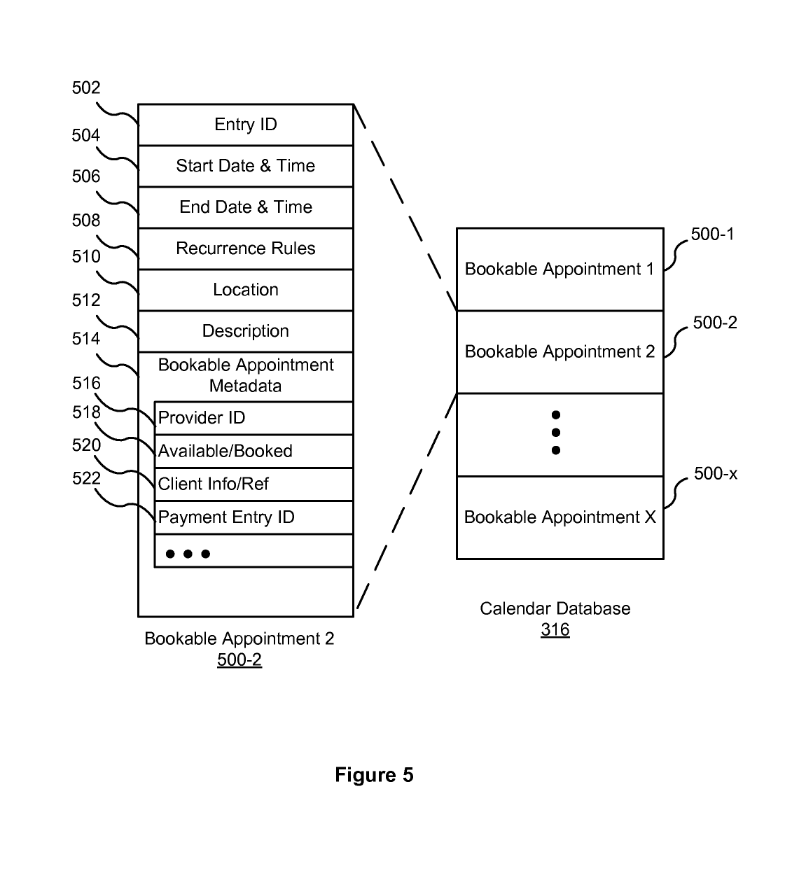

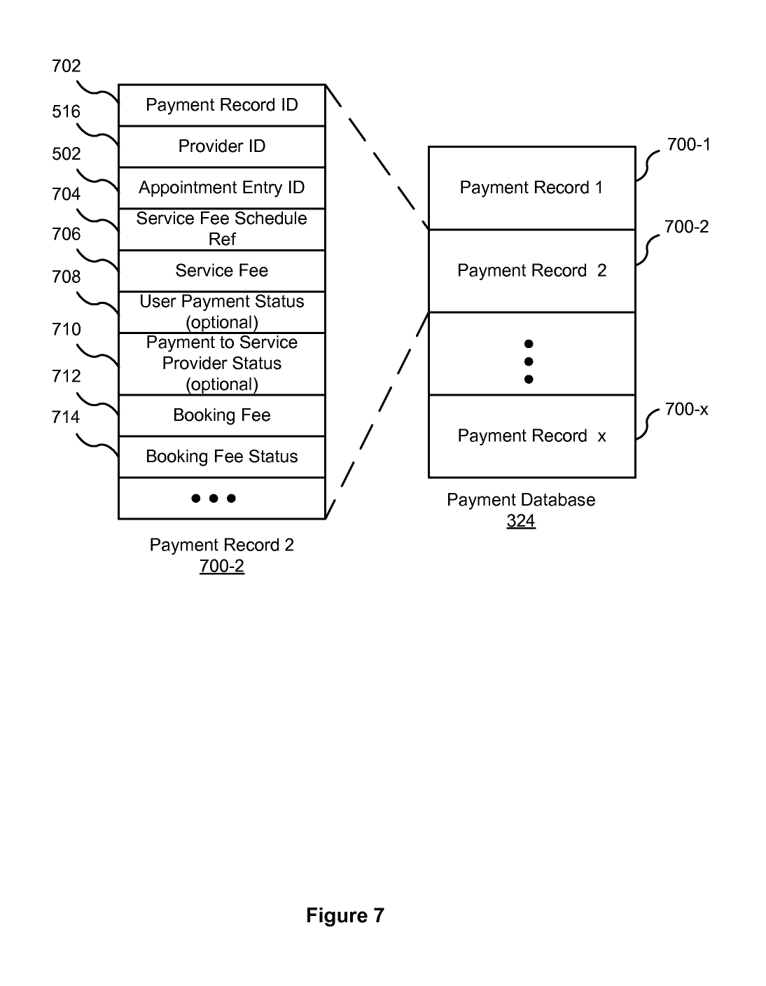

In some embodiments, calendar engine 114 includes a calendar database 316 to store calendar information to be provided to clients 102 and service provider computers 104, an appointment booking processing module 116 to process user requests to schedule appointments with the service provider, and a calendar search program 318 to determine that an appointment request can be accepted, as well as the scheduling webpage 320. In some embodiments, calendar database 316 includes bookable appointment records 500, described below with respect to FIG. 5. In some embodiments, payment database 324 includes payment records 700, described below with respect to FIG. 7, and service provider debit accounts 325.

Each of the above identified modules and applications correspond to a set of instructions for performing one or more functions described above. These modules (i.e., sets of instructions) need not be implemented as separate software programs, procedures or modules, and thus various subsets of these modules may be combined or otherwise re-arranged in various embodiments. In some embodiments, memory 306 or the non-transitory computer readable storage medium of memory 306 may store a subset of the modules and data structures identified above. Furthermore, memory 306 or the computer readable storage medium of memory 306 may store additional modules and data structures not described above.

Although FIG. 3 shows calendar server system 108 as a number of discrete items, FIG. 3 is intended more as a functional description of the various features which may be present in calendar system 108 rather than as a structural schematic of the embodiments described herein. In practice, and as recognized by those of ordinary skill in the art, items shown separately could be combined and some items could be separated. For example, some items shown separately in FIG. 3 could be implemented on single servers and single items could be implemented by one or more servers. The actual number of servers in calendar system 108 and how features are allocated among them will vary from one implementation to another, and may depend in part on the amount of data traffic that the system must handle during peak usage periods as well as during average usage periods.

FIG. 4A is a block diagram illustrating an embodiment of a client 102, also called a client system or client device, in accordance with some embodiments. The client 102 shown in this figure is configured for use by a user of calendar system 108. Client 102 includes a user interface 400, which typically includes a display device 401, and one or more input devices 403 such as a keyboard and a mouse or other pointing device (e.g., a stylus, touch-sensitive surface, or touch-sensitive display). Client 102 includes a graphical user interface (GUI) 110, which is displayed on the display device 401. Client 102 typically includes one or more processing units (CPUs) 402, one or more network or other network communications interfaces 404, memory 406, and one or more communication buses 408 for interconnecting these components. The communication buses 408 may include circuitry (sometimes called a chipset) that interconnects and controls communications between system components.

Memory 406 includes high-speed random access memory, such as DRAM, SRAM, DDR RAM or other random access solid state memory devices; and may include non-volatile memory, such as one or more magnetic disk storage devices, optical disk storage devices, flash memory devices, or other non-volatile solid state storage devices. Memory 406 may optionally include one or more storage devices remotely located from the CPU(s) 402. Memory 406, or alternately the non-volatile memory device(s) within memory 406, comprises a non-transitory computer readable storage medium. In some embodiments, memory 406 or the non-transitory computer readable storage medium of memory 406 stores the following programs, modules and data structures, or a subset thereof:
Operating System 410 that includes procedures for handling various basic system services and for performing hardware dependent tasks;
Network Communication Module (or instructions) 412 that is used for connecting client 102 to other computers (e.g., calendar system 108 and service provider computers 104) via the one or more communications Network Interfaces 404 (wired or wireless) and one or more communication networks 106 (FIG. 1), such as the Internet, other wide area networks, local area networks, metropolitan area networks, and so on;
Browser Application 414; optionally, the browser application 414 or an extension, plug-in or toolbar of the browser application includes a client assistant 416 that handles data formatting and/or management tasks, at least some of which would otherwise be handled by presentation module 326 (FIG. 3); and
Scheduling Webpage 418 (e.g., as shown in FIG. 9B), which is a webpage received from calendar system 108, for receiving a user request to schedule an appointment with a service provider, and for presenting available time slots of a service provider in GUI 110; webpage 418 optionally includes an embedded Scheduling Module 420, for receiving appointment requests from a user and for formatting schedule data for display in GUI 110.

In some embodiments, client 102 may be a “thin client,” which includes a browser application 414 that displays the scheduling webpage 418 received from calendar system 108. In this embodiment, client 102 only displays the scheduling webpage, and executes programs, if any, embedded within scheduling webpage 418, but includes little if any additional software. In some embodiments, programs embedded within the scheduling webpage 418 format schedule data for display. In thin client embodiments, schedule-related processing other than user data input and schedule data display are handled by calendar system 108.

FIG. 4B is a block diagram illustrating an embodiment of a service provider computer 104, also called a service provider system or service provider device, in accordance with some embodiments. Service provider computer 104 has most of the same elements as the client 102 discussed in FIG. 4A. In fact, the same computer system may act as a service provider computer 104 and a client 102. For example, an individual may use the same computer system to be a provider of a particular service as well as a user requesting appointments with other service providers. Service provider computer 104 shown in this figure is configured for use by a service provider using calendar system 108. The client service provider computer 104 includes an interface 400, which typically includes a display device 401, and one or more input devices 403 such as a keyboard and a mouse or other pointing device (e.g., a stylus, touch-sensitive surface, or touch-sensitive display). Service provider computer 104 includes a graphical user interface (GUI) 110, which is displayed on the display device 401. Service provider computer 104 typically includes one or more processing units (CPUs) 402, one or more network or other network communications interfaces 404, memory 406, and one or more communication buses 408 for interconnecting these components. The communication buses 408 may include circuitry (sometimes called a chipset) that interconnects and controls communications between system components.

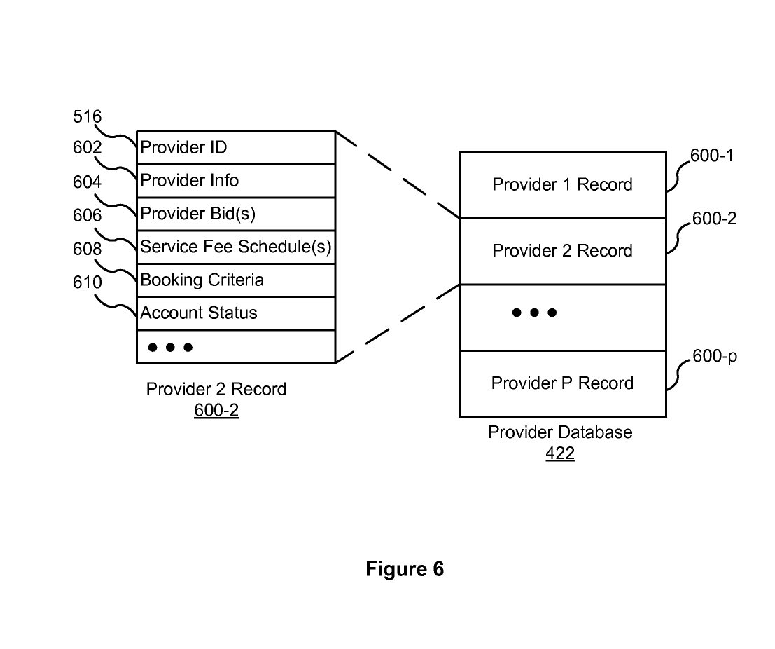

Memory 406 includes high-speed random access memory, such as DRAM, SRAM, DDR RAM or other random access solid state memory devices; and may include non-volatile memory, such as one or more magnetic disk storage devices, optical disk storage devices, flash memory devices, or other non-volatile solid state storage devices. Memory 406 may optionally include one or more storage devices remotely located from the CPU(s) 402. Memory 406, or alternately the non-volatile memory device(s) within memory 406, comprises a non-transitory computer readable storage medium. In some embodiments, memory 406 or the non-transitory computer readable storage medium of memory 406 stores the following programs, modules and data structures, or a subset thereof:
Operating System 410 that includes procedures for handling various basic system services and for performing hardware dependent tasks;
Network Communication Module (or instructions) 412 that is used for connecting service provider computer 104 to other computers (e.g., calendar system 108 and clients 102) via the one or more communications Network Interfaces 404 (wired or wireless) and one or more communication networks 106 (FIG. 1), such as the Internet, other wide area networks, local area networks, metropolitan area networks, and so on;
Browser Application 414; optionally, browser application 414 or an extension, plug-in or toolbar of the browser application includes a client assistant 416 that handles data formatting and/or management tasks, at least some of which would otherwise be handled by presentation module 326 (FIG. 3);
Scheduling Webpage 418, which is a webpage received from calendar system 108, for receiving the service provider's calendar including available timeslots and presenting booked appointments to the service provider in GUI 110, webpage 418 optionally includes an embedded Scheduling Module 420, for receiving the service provider's calendar and for formatting schedule data for display in GUI 110; and
An optional Provider Database 422, which stores a variety of service provider information (e.g., the service provider's fee schedule for services offered, booking bids, booking criteria, etc.) in provider records 600, as explained in more detail with respect to FIG. 6.

In some embodiments, service provider computer 104 may be a “thin service provider computer,” analogous to a thin client, which includes a browser application 414 that displays scheduling webpage 418 received from calendar system 108. In this embodiment, service provider computer 104 only displays the scheduling webpage, and executes programs, if any, embedded within the scheduling webpage 418, but includes little if any additional software. In some embodiments, programs embedded within scheduling webpage 418 format schedule data for display. In thin service provider computer 104 embodiments, schedule-related processing other than service provider calendar data input and schedule data display are handled by calendar system 108.

FIG. 5 is a block diagram illustrating an exemplary calendar database 316 (FIG. 3) and an exemplary bookable appointment record 500-x in accordance with some embodiments of the invention. Calendar database 316 stores bookable appointment records 500, for example bookable appointment 1 (500-1) through bookable appointment x (500-x), where x represents the number of bookable appointments stored in the calendar database 316.

A bookable appointment (e.g., bookable appointment record 2 500-2) includes the following data, or a subset or superset thereof, for a bookable appointment (which can be either a booked appointment or an open appointment that has not yet been booked):
Entry ID 502 (e.g., an n-bit binary number) that uniquely identifies a particular bookable appointment;
Start date and/or start time 504 of the bookable appointment;
End date and/or end time 506 of the bookable appointment;
Recurrence rules 508 (if any) for the bookable appointment (e.g., whether the bookable appointment occurs only once or recurs periodically, for example, daily, weekly, every other week, monthly, yearly, etc.), including an end date for the recurrence;
Location 510 (e.g., postal address, room, etc.) of the bookable appointment;
Description 512 (e.g., title and description details such as service options available, services booked, color coding, name(s) of technicians available or booked for a particular service, etc.); and
Bookable Appointment metadata, including a provider ID 516 used to identify the service provider and other provider information in the provider database 422, an available/booked marker 518 used to indicate whether the bookable appointment is an open or filled timeslot (in embodiments such as classes that have a maximum number of seats or participants, this indicator includes a booked headcount), a client information reference 520 used to identify the user who has booked the appointment (used, for example, when the user pays calendar system 108 for the services provided by the service provider), and a payment entry ID 522 used to identify various payment information discussed with respect to FIG. 6.

In some embodiments, calendar system 108 includes a separate calendar database 316 for each service provider.

FIG. 6 is a block diagram illustrating exemplary service provider records 600 in the service provider database 422 (FIG. 4B), in accordance with some embodiments. Service provider database 422 stores provider records 600, for example Provider 1 Record (600-1) through Provider P Record (500-p), where p represents the number of providers for which the database 422 stores records.

A provider record 600 (e.g., Provider 2 Record 600-2) includes the following data, or a subset or superset thereof, for a provider:
Provider ID 516 (e.g., an n-bit binary number) that uniquely identifies a particular service provider and is cross referenced in various other databases;
Provider Information 602, which includes various information about the service provider (e.g., the name of the service provider's business, contact information, descriptions of services offered, etc.);
Provider Bid(s) 604, also referred to as a booking bid, which is the amount of money the service provider has bid to pay for each successfully booked appointment;
Service Fee Schedule(s) 606, which list the fees for the services provided by the service provider; in some embodiments, the service provider's technicians may each have a respective (e.g., unique) service fee schedule;
Booking Criteria 608, which include the requirements for an appointment request to be accepted; and
Account Status 610, which includes information about the service provider's account (e.g., whether money is in the account for debiting appointment booking fees).

In some embodiments, a respective provider bid of provider bids 604 is a set amount, a fixed percentage of the service fees charged, or an amount determined in accordance with a bid schedule in which a variety of factors are taken into account to determine the bids, such as how far away the open time slot is from the present time. In one example, the booking criteria 608 includes a rule that a respective provider accepts appointment requests only from users who have proof of insurance. In another example, the booking criteria 608 includes a rule that a respective provider accepts appointment requests only from pre-approved users, such as people already enrolled at a particular school or university, people with a particular medical insurance, etc.

FIG. 7 is a block diagram illustrating exemplary payment records 700 in the payment database 324 (FIG. 3), in accordance with some embodiments. Payment database 324 stores payment records 700 for booked appointments, for example Payment Record 1 (700-1) through Payment Record x (700-x), where x represents the number of payment records stored in the payment database 324.

A payment record 700 (e.g., payment record 700-2) includes the following data, or a subset or superset thereof for a booked appointment:
Payment record ID 702 (e.g., an n-bit binary number) that uniquely identifies a particular payment record;
Provider ID 516 (e.g., an n-bit binary number) that uniquely identifies a particular service provider cross referenced in various other databases;
Appointment Entry ID 502 for the booked appointment for which the payment entry corresponds;
Service Fee Schedule(s) Reference 704, which references the provider's service fee schedule 606 (FIG. 6);
Service Fee 706, which stores the fee for the service provided by the service provider for the corresponding booked appointment, taking into account any discounts, etc.;
Optional User Payment Status 708, which indicates whether or not the user has paid for the services, to be updated when calendar system 108 collects the service fees from the user and provides a portion of them to the service provider, or to be recorded by the service provider when collecting payments directly from the users;
Optional Payment to Service Provider Status 710, which indicates whether collected service fees have been paid to the respective service provider. Optionally, when calendar system 108 collects service fees from a user, calendar system 108 may hold the service fees until a pre-determined event, such as the performance of the services or expiration of a refund period. In some other embodiments, service fees are paid immediately or periodically to the service provider, while in other embodiments they are deposited into the service provider's account;
Booking Fee 712, which is the fee that the service provider pays to calendar system 108 for the successfully booked appointment (e.g., determined from the service provider's booking bid(s) 606 (FIG. 6)); and
Booking Fee Status 714, which indicates whether the booking fee has been paid (or debited from the service provider's debit account 325 (FIG. 3)). In some embodiments, the booking fee is not charged until a pre-determined period has passed (e.g., until a pre-determined time prior to the appointment has been reached, for example 24 hours before the appointment, and the appointment has not been cancelled).

FIGS. 8A-8C are flowcharts representing a computer-implemented method of booking an appointment, in accordance with some embodiments. In accordance with some embodiments, the method allows a user to book an appointment with a service provider, and allows the service provider to pay an advertising fee for the successfully booked appointment. In some embodiments, the method is performed on a computer system (e.g., calendar system 108, FIGS. 1 and 3) having one or more processors (e.g., CPU(s) 302, FIG. 3) and memory (e.g., 306, FIG. 3) storing one or more programs which when executed by the one or more processors cause performance of the following method.

As explained with reference to FIG. 2, to allow users to book appointments through calendar system 108, the service provider sets up an account with calendar system 108. In some embodiments, calendar system 108 receives calendar information, criteria for accepting user appointments, and a service fee schedule from service provider computer 104 (802). The calendar information may include all of the service provider's calendar events, or may include specified blocks of time in the service provider's calendar.

In some embodiments, the service fee schedule is unique to each service provider, as each service provider may charge unique amounts (potentially varying by the technician providing the services), and may also provide a variety of discounts to its customers. In some embodiments, calendar system 108 uses the fee schedule to provide automated invoicing and collecting of the service fees as described in more detail below. In other embodiments, the fee schedule is provided for informational purposes only, since the service provider will collect the service fees directly.

In some embodiments, the criteria for accepting appointments, (i.e., the appointment constraints) are likewise unique to the service provider. Some criterion examples are appointment duration and appointment location. In some embodiments, the appointment constraints include a list of one or more specified users allowed (or not allowed) to book (or view) an appointment during one or more specified time slots (804). In some embodiments, certain users may be given preferential treatment for certain timeslots. This preferential treatment is offered, for example, during a specified period of time, outside of which (e.g., after which) it is not offered. For example, on Monday and Tuesday a professor may hold Wednesday-Friday afternoons open for students to book one-on-one study sessions, but by Wednesday any remaining slots are open to anyone wishing to book the professor's time. In other embodiments, a criterion merely specifies time slots in which any user is allowed to book an appointment (806). In some embodiments, a criterion specifies a maximum number of participants allowed to book an appointment during one or more time slots (808). This maximum number may be for either the same appointment slot or for concurrently available appointments. For example, the same time slot may be available to many users if a service provider offered a class with a maximum number of seats available. Concurrently available appointments would exist, for example, where the service provider has more than one employee, each of whom is available for a respective appointment. For example, more than one hairdresser may be available at a given time in a single service provider's salon.

In some embodiments, as a part of the account set up, calendar system 108 also receives from service provider computer 104 a booking bid or booking bid schedule for determining a fee paid for each successfully booked appointment (810). For example, the service provider may bid that for each successfully booked appointment, the service provider will pay a set percentage of the total cost of the appointment. Alternatively, the service provider may offer a set bid amount, such as N dollars per appointment. In other examples, a bid fee calculation takes into account a variety of factors.

Once the service provider's account is set up, calendar system 108 is ready to book appointments. Calendar system 108 receives a search request from a client computer 102 associated with a user (812). In some embodiments the search request will include a request for the service provider's calendar (814). In other embodiments, the search request will be more general, rather than being calendar specific.

In response to the search request, calendar system 108 provides search results matching the search request (e.g., as shown in FIG. 9A), including a link corresponding to the service provider, to the client computer 102 associated with the user (816). In some embodiments, the service provider link is associated with an advertisement concurrently displayed with the search results (818). In other embodiments, at least one of the search results will include the service provider's link. In some embodiments the service provider's link includes a calendar icon, which indicates to the user that the service provider's calendar is available for accepting bookings.

Furthermore, in some embodiments, when several service provider links are provided, the service provider links are ranked according to the respective booking bids associated with the links (820). For example, a service provider that offered a higher booking bid (in step 810) would be presented in the search results above a service provider that offered a lower booking bid. In other embodiments, the search results and provider links are ordered strictly based on relevance factors (e.g., PageRank), so that the most relevant search results and links are provided higher in the list of search results. In still other embodiments, a combination of relevant factors and booking bid amounts are used to determine the order in which service provider links are ranked in step (820).

Calendar system 108 provides a calendar view (e.g., calendar view 950, FIG. 9B) showing available time slots of a service provider to the client computer 102 for viewing by the user (822). It should be noted that in most embodiments the user is distinct from the service provider. Although in some embodiments, the service provider can also use calendar system 108 to enter manually any appointments that were booked in person, over the phone, or by another means. In some embodiments in which the service provider books appointments directly, the service provider is not charged as it is for user-booked appointments.) In some embodiments, the service provider's calendar is displayed upon user selection of the service provider link. In other embodiments, the service provider's calendar is displayed in response to a specific search request for service provider calendars. One or more service provider calendars may be displayed in response to the specific search request for service provider calendars. As such, the user may be able to compare available appointment times of several comparable service providers simultaneously (for example, hair cut appointment times available in the San Francisco Mission neighborhood during a specified period of time.)

In some embodiments, a view of the user's calendar is overlaid with the service provider's calendar (824). As such, the available time slots for both the user and the service provider are visually distinguished from timeslots unavailable for the user, the service provider, or both. For example, available and/or unavailable time slots for each of the user and the service provider are displayed in distinct respective colors (e.g., semi-transparent colors), which combine into other colors when overlaid. In one example, the user's booked events are displayed in a semi-transparent green, the service provider's booked events are displayed in a semi-transparent blue, and the available timeslots for both the user and service provider are displayed in yellow, in which case only the available timeslots for both the user and service provider are yellow.

In some embodiments, a criterion for accepting appointments (at operation 804) specifies a list (e.g., received from service provider computer 104) of one or more specified users allowed to book an appointment during one or more specified time slots. For example, only students registered at a particular university are allowed to register for next semester's available classes. In these instances, the calendar view of specified timeslots is provided only to qualified users (826). (The qualified users are the same users specified at step 804.) Furthermore, in some embodiments, if the user is not one of the specified users, the calendar view is modified so that the available time slots shown in the calendar view exclude the specified timeslots that are only available to the specified users, but include the remaining available timeslots.) Similarly, in some embodiments, after a predetermined number of specified users have booked appointments during specified time slots, the calendar system will make any remaining time slots available for booking by users other than the specified users (such as for the Professor's office hours example discussed above).

The process continues in FIG. 8B. In some embodiments, when the service provider has an available timeslot that meets certain discount criteria, a discount offer is sent to the user (828). For example, when the service provider has an available timeslot within a predetermined period of time from a current time, a discount offer is sent from the service provider to the user (e.g., to the client 102 associated with the user). In some embodiments the discount offer may be provided by email, instant message (IM), or other mode of communication. In other embodiments, the discount offers are displayed on the service provider's calendar. In other words, the discount offer is displayed to users currently viewing the service provider's calendar (830). In some embodiments, the discount-offer timeslots are visually distinguished from other timeslots (e.g., they may be displayed in a different color from other timeslots.) In other words, when the service provider has an available timeslot that meets discount criteria, providing the calendar view (operation 822) may further include visually distinguishing the timeslot meeting the discount criteria from other timeslots that do not meet the discount criteria.

In some embodiments, discount offers are sent to users who have previously booked appointments with the service provider (832). For example, calendar system 108 does not provide discount offers to the clients 102 in or along with a calendar view, but instead sends the discounts to users by another mode of communication (e.g., via email or IM)..

Calendar system 108 receives from the client computer 102 associated with the user an appointment request to schedule an appointment with the provider (834). It should be noted that the term “appointment” herein includes appointments or reservations for all types of services, equipment, and events that can be booked using the calendar system described herein. For example, doctor appointments, salon appointments, classes, plumber visits, office hours for a professor, rental equipment reservations, and meetings are considered appointments. In some embodiments, the user submits an appointment request via client 102 by selecting an available timeslot on the service provider's calendar. In other embodiments, the user selects a timeslot and a particular service, if more than one service is available from the service provider. In still other embodiments, the user selects or indicates a schedule range in which the user is available, and allows calendar system 108 to specify the particular time slot.

Calendar system 108 determines that the appointment request can be accepted (836). In some embodiments, this determination is based on the service provider's availability (838). In some embodiments, the calendar system determines that the appointment request can be accepted in accordance with the received appointment constraints (provided in operations 802-808). For example, this determination may be based upon the user being on the list of one or more specified users allowed to book an appointment with the service provider (e.g., a doctor may only allow patients with certain insurance to book with him.) In still other embodiments, this determination is based on the number of participants the service provider can accommodate simultaneously (840). For example, the service provider may allow up to N simultaneous bookings for a certain presentation, movie, or class.

In some embodiments, the service provider is allowed to accept or deny the appointment (842). For example, calendar system 108 sends the appointment request to service provider computer 104 and receives a response accepting or denying the appointment. In other embodiments, the determination as to whether the appointment can be accepted is done automatically and the service provider does not individually accept or deny appointments.

The process continues in FIG. 8C. Calendar system 108 books the appointment (844). In some embodiments the appointment is booked upon determining that the appointment request can be accepted. In some embodiments, the calendar view of the service provider is automatically updated by calendar system 108 to reflect that the appointment has been booked (846). As such, the user can confirm that the appointment was accepted by seeing that the service provider's calendar now includes the user's appointment (or at least that the appointment time is now blocked out, because in some embodiments the service provider's calendar view available to users will not include information about which user booked which appointment but will instead indicate only whether an appointment time is available or not.) In some embodiments, the appointment is automatically added to the calendar view of the user (848). This is an additional way that the user can verify that the appointment has been successfully booked. In some embodiments, a confirmation message is provided, either on screen, with an optional confirmation number, or via email or other communication system, to the user confirming the booking. In some embodiments, the appointment added to the user's calendar includes the contact information and other information about the service provider, thus making repeat business more likely for the service provider because the user has the contact information for the service provider already saved in his calendar. In some embodiments, a booking notification is sent to the service provider. Likewise in some embodiments, one or more reminder messages are sent to the user reminding him of the upcoming booked appointment. Reminder messages help reduce the number of forgotten appointments and no-shows for the service provider.

In some embodiments, calendar system 108 optionally provides an invoice for the service provided by the service provider to the user (850). In some embodiments, the invoice is for only a portion of the services, and acts as a hold fee for the appointment. In some embodiments the invoice is provided directly after the booking, and before the service is performed (852). In other embodiments, the invoice is not provided until after the time of the appointment, and thus after the service has supposedly been provided by the service provider. In some embodiments, the service provider collects the service fee directly from the user. However, the option provided here gives the service provider the option of allowing the calendar system to handle payment collections. In embodiments where a discount is available (such as those discussed with respect to operations 828-832), a discount offer is applied to the invoice (854).

In embodiments where calendar system 108 provides the invoice for the services provided, calendar system 108 accepts payment from the user for the invoice (856). Then calendar system 108 sends at least a portion of the payment to the service provider (858). The calendar system may also allow or encourage the user to add a gratuity for the service provider to the service payment. This sending may include depositing the invoice payments into a service provider account (e.g. debit account 325, FIG. 3). A handling fee may be withdrawn from the service payment, which is why, in some embodiments, only a portion of the payment is provided to the service provider. Furthermore, in embodiments where a service provider account is maintained, the service provider account may also be used to pay for booking fees as described below.

After booking the appointment, calendar system 108 charges the service provider a booking fee for the booked appointment (860). As discussed with respect to operation 810, the booking fee is an amount that the service provider bid to pay for each successfully booked appointment. In some embodiments the booking fee is a pre-arranged flat fee. In other embodiments the fee is determined based on a plurality of fee calculation factors (862). For example, in some embodiments, the booking fee is determined according to a formula taking into account the cost of the service provided as well as an additive and/or multiplicative factor (e.g., a percentage) specified by the booking bid. In some embodiments, the charging of the booking fee is deferred until a pre-determined criterion has been met (864). Examples of the pre-determined criteria include: whether the user is qualified to book the appointment, whether the appointment was not cancelled for at least a predefined period of time following the booking of the appointment or prior to the appointment, whether payment was received from the user, whether payment information of the user was verified, whether insurance information for the user was verified, and whether the user has completed a registration process. For example, the booking fee may not be charged until the appointment has passed, or it may not be charged until a specified period of time (e.g., N day or hours) before the appointment (assuming that the user or the service provider has not cancelled the booked appointment in the interim.)

Finally, the service provider pays the fee (or the fee is debited from the service provider's account) such that calendar system 108 receives the booking fee for the successfully booked appointment between the user and the service provider (866). In some embodiments, when the fee is debited from the service provider's account and the account is also used to collect the payments from the users for the services provided, the service provider allows the calendar system to handle all of the payment transactions as well as the appointment booking transactions with minimal oversight. Whether the service provider uses the calendar system just for booking appointments, or whether the service provider also uses the calendar system for invoicing users for the services provided, the service provider has more time to devote to providing services to users and less headaches involved with maintaining the calendars and at least some of the accounting associated with running a business.

Each of the operations shown in FIGS. 8A-8C may correspond to instructions stored in a computer memory or non-transitory computer readable storage medium. The computer readable storage medium may include a magnetic or optical disk storage device, solid state storage devices such as Flash memory, or other non-volatile memory device or devices. The computer readable instructions stored on the computer readable storage medium are in source code, assembly language code, object code, or other instruction format that is interpreted by one or more processors.

FIGS. 9A-9B are schematic screen shots of exemplary graphical user interfaces for booking appointments in accordance with some embodiments of the present invention. FIG. 9A illustrates an example of search results 902 that are presented to a user in response to a search request, according one embodiment. These search results include a link 904 corresponding to a service provider. In some embodiments, upon the user selection of the link 904, a calendar view 950 like that shown in FIG. 9B would appear. In some embodiments, calendar view 950 is displayed as an overlay over the search results or as a pop-up window.

FIG. 9A illustrates an embodiment of search results 902 as provided, for example, in the operation 816 (FIG. 8A) and displayed in the GUI 110 of a client 102 (FIG. 1). In this embodiment, the search results 902 are presented in response to the search query “spa San Francisco” 906, provided in the search query entry box 908. A link to a service provider 904 associated with San Francisco spas is presented. In some embodiments, the link 904 includes a calendar icon 910, which indicates to the user that the service provider's calendar is available for accepting bookings.

In the embodiment shown in FIG. 9A, the service provider link 904 is a part of the “sponsored links” 912: it is a link associated with advertisements, and it is concurrently displayed with the regular search results, entitled “un-sponsored search results” 914 in this figure. In other embodiments, at least one of the regular “un-sponsored search results” will include the service provider's link 904. In some embodiments, more than one service provider and their accompanying links will be presented, but for ease of illustration, only one service provider link 904 is shown in FIG. 9A.

In the embodiments shown in FIG. 9A, additional information 918 about the service provider is also displayed. In some embodiments, this information 918 is displayed when a user controlled cursor 916 hovers over a display region occupied by the service provider's link 904, as shown here. In some embodiments, the additional information 918 includes a location map 920, a star rating 922, a link to reviews 924, a postal address 926, a website address 928, additional links 930 (such as “get directions”), and also includes a calendar icon 910, which indicates to the user that the service provider's calendar is available for accepting bookings. The user can click on the calendar icon 910 in either the original service provider link 904 or in this additional information 918 bubble. Upon selection of the service provider's calendar icon 910 the user will be taken to a calendar view 950 like that shown in FIG. 9B.

FIG. 9B illustrates an embodiment of a calendar view 950 used by a service provider for booking appointments with users, and is an example of a calendar view in the operation 822 (FIG. 8A). Calendar view 950 shows available timeslots 952 for the service provider as well as unavailable timeslots 954 (indicated here by a blank box without an active link). In this embodiment, in order to book an appointment, the user selects the link associated with the available timeslot 952. In some embodiments, the appointment details are verified in a verification message 955 upon user selection of an available timeslot 952. In FIG. 9B, the modality 956, therapist 958, and duration 960 are indicated to the user for verification in the verification message 955. A variety of appointment options are available in the calendar view. In this embodiment, the user selected the service “Swedish massage” 962 lasting “1 hour” 964. The appointment times in calendar view 950 are times at which one hour Swedish massage services are offered. In other embodiments, calendar view 950 indicates available times for multiple services, wherein each available time slot 952 has at least one service available.

Once the user is satisfied with the appointment details, the user can request to schedule the appointment with the service provider. In this embodiment, the request to schedule the appointment is initiated by the user selecting the “reserve now” button 966. In response, client 102 sends an appointment request to calendar system 108, which receives the request as described in the operation 834 (FIG. 8B). Optionally, the user can choose to pay for the services at this point as well. Selecting the “pay now” button 968 allows the user to initiate payment for the services using the calendar system.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated.

1. A computer-implemented method of booking appointments, the method comprising:
providing, sing one or more processors, a first view of a first calendar showing available time slots of a service provider to a user;
receiving, using the one or more processors, from the user an appointment request to schedule an appointment with the service provider;
upon determining that the appointment remains available, causing, using the one or more processors, the appointment to be booked for the user; and
in response to a successful booking of the appointment, charging, using the one or more processors, the service provider a pre-arranged transaction fee for the booked appointment, and updating the first view of the first calendar having the available time slots of the service provider, and a second calendar having available time slots of the user, to both include the booked appointment, the second calendar being distinct from the first calendar.

2. The method of claim 1, comprising:
prior to providing the first view of the first calendar, receiving a search request from the user;
providing to the user a response that includes search results matching the search request, the response including a link corresponding to the service provider; and
upon a user selection of the link corresponding to the service provider, providing the first view of the first calendar to the user.

3. The method of claim 1, wherein charging the service provider the pre-arranged transaction fee is deferred until one or more additional criteria are satisfied, wherein the additional criteria include at least one of:
determining that the user is qualified to book the appointment,
determining that the appointment was not cancelled for at least a predefined period of time following the booking of the appointment,
receiving payment from the user,
verifying payment information of the user,
verifying insurance information for the user, and
determining that the user has completed a registration process.

4. The method of claim 1, further comprising:
providing for display a second view of the second calendar showing the available timeslots of the user overlaid with the first view of the first calendar showing the available timeslots of the service provider such that the available time slots for both the user and the service provider are visually distinguished from timeslots unavailable for the user or the service provider.

5. The method of claim 1, further comprising:
receiving, from the service provider, a list of one or more specified users allowed to book an appointment during one or more specified time slots; and
after a predetermined number of the specified users have booked appointments during the specified time slots, making any remaining time slots of the specified time slots available for booking by users other than the specified users.

6. The method of claim 1, further comprising:
receiving, from the service provider, a list of one or more specified users allowed to book an appointment during one or more specified time slots; and
when the user is not one of the specified users, excluding the specified time slots from the available time slots shown in the first view of the first calendar.

7. The method of claim 1, further comprising:
after booking the appointment and prior to the appointment, providing an invoice for the appointment to the user;
accepting payment from the user for the invoice prior to the appointment; and
sending at least a portion of the payment to the service provider.

8. The method of claim 7, further comprising:
when the service provider has an available timeslot within a predetermined period of time from a current time, offering a discount to the user; and
prior to accepting the payment from the user, applying the discount to the invoice.

9. The method of claim 1, further comprising:
after the appointment, providing an invoice for the appointment to the user;
accepting payment from the user for the invoice; and
sending at least a portion of the payment to the service provider.

10. The method of claim 1, further comprising:
when the service provider has an available timeslot that meets discount criteria, providing the first view of the first calendar comprises:
visually distinguishing the timeslot meeting the discount criteria on the first view of the first calendar.

11. The method of claim 1, further comprising:
receiving appointment constraints from the service provider, and
determining that the appointment request can be accepted in accordance with the received appointment constraints, wherein the appointment constraints include one or more of the following:
appointment duration;
specified users allowed to book appointments;
specified users not allowed to book appointments;
a number of seats available for a set appointment time;
a number of concurrently available appointments; and
appointment location.

12. The method of claim 1, wherein the booking comprises automatically updating the first calendar of the service provider to include the booked appointment.

13. The method of claim 1, wherein the booking comprises automatically adding the appointment to the second calendar of the user.

14. The method of claim 1, further comprising:
prior to the booking, allowing the service provider to accept or deny the appointment.

15. A computer system for booking appointments, the computer system comprising:
one or more processors for executing programs; and
memory storing one or more programs to be executed by the one or more processors;
the one or more programs comprising instructions for:
providing a first view of a first calendar showing available time slots of a service provider to a user;
receiving from the user an appointment request to schedule an appointment with the service provider;
upon determining that the appointment remains available, causing the appointment to be booked for the user; and
in response to a successful booking of the appointment, charging the service provider a pre-arranged transaction fee for the booked appointment, and updating the first calendar having the available time slots of the service provider.

16. The system of claim 15, the one or more programs further comprising instructions for:
prior to providing the first view of the first calendar, receiving a search request from the user;
providing to the user a response that includes search results matching the search request, the response including a link corresponding to the service provider; and
upon a user selection of the link corresponding to the service provider, providing the first view of the first calendar to the user.

17. The system of claim 15, wherein the instructions for charging the service provider comprise instructions for deferring charging the service provider the pre-arranged transaction fee until one or more additional criteria are satisfied, wherein the additional criteria include one of:
determining that the user is qualified to book the appointment,
determining that the appointment was not cancelled for at least a predefined period of time following the booking of the appointment,
receiving payment from the user,
verifying payment information of the user,
verifying insurance information for the user, and
determining that the user has completed a registration process.

18. The system of claim 15, the one or more programs further comprising instructions for:
providing for display a second view of a second calendar showing available timeslots of the user overlaid with the first view of the first calendar showing the available timeslots of the service provider such that the available time slots for both the user and the service provider are visually distinguished from timeslots unavailable for the user or the service provider.

19. The system of claim 15, the one or more programs further comprising instructions for:
after booking the appointment, providing an invoice for the appointment to the user;
accepting payment from the user for the invoice; and
sending at least a portion of the payment to the service provider.

20. The system of claim 19, the one or more programs further comprising instructions for:
when the service provider has an available timeslot within a predetermined period of time from a current time, offering a discount to the user; and
prior to accepting the payment from the user, applying the discount to the invoice.

21. The system of claim 15, the one or more programs further comprising instructions for:
after the appointment, providing an invoice for the appointment to the user;
accepting payment from the user for the invoice; and
sending at least a portion of the payment to the service provider.

22. The system of claim 15, the one or more programs further comprising instructions for:
when the service provider has an available timeslot that meets discount criteria, visually distinguishing the timeslot meeting the discount criteria on the first view of the first calendar.

23. The system of claim 15, the one or more programs further comprising instructions for:
receiving appointment constraints from the service provider, and
determining that the appointment request can be accepted in accordance with the received appointment constraints, wherein the appointment constraints include one or more of the following:
appointment duration;
specified users allowed to book appointments;
specified users not allowed to book appointments;
a number of seats available for a set appointment time;
a number of concurrently available appointments; and
appointment location.

24. (canceled)

25. The system of claim 15, wherein the instructions for booking the appointment comprise instructions for automatically adding the appointment to the second calendar of the user.

26. The system of claim 15, the one or more programs further comprising instructions for allowing the service provider to accept or deny the appointment, prior to booking the appointment.

27. A non-transitory computer readable storage medium storing one or more programs configured for execution by a computer system for booking appointments, the one or more programs comprising instructions for:
providing a calendar view showing available time slots of a service provider to a user;
receiving from the user an appointment request to schedule an appointment with the service provider;
upon determining that the appointment remains available, causing the appointment to be booked for the user; and
in response to a successful booking of the appointment, charging the service provider a pre-arranged transaction fee for the booked appointment, and updating the calendar view showing the available time slots of the service provider.

28. The computer readable storage medium of claim 27, the one or more programs further including instructions for:
prior to providing the calendar view, receiving a search request from user;
providing to the user a response that includes search results matching the search request, the response including a link corresponding to the service provider; and
upon a user selection of the link corresponding to the service provider, providing the calendar view to the user.

29. The computer readable storage medium of claim 27, wherein the instructions for charging the service provider comprise: instructions for deferring charging the service provider the pre-arranged transaction fee until one or more additional criteria are satisfied, wherein the additional criteria include one of:
determining that the user is qualified to book the appointment,
determining that the appointment was not cancelled for at least a predefined period of time following the booking of the appointment,
receiving payment from the user,
verifying payment information of the user,
verifying insurance information for the user, and
determining that the user has completed a registration process.

30. The computer readable storage medium of claim 27, the one or more programs further comprising instructions for:
providing for display another calendar view showing available timeslots of the user overlaid with the calendar view showing the available timeslots of the service provider such that the available time slots for both the user and the service provider are visually distinguished from timeslots unavailable for the user or the service provider, wherein the user is distinct from the service provider.

31. The computer readable storage medium of claim 27, the one or more programs further comprising instructions for:
after booking the appointment, providing an invoice for the appointment to the user;
accepting payment from the user for the invoice; and
sending at least a portion of the payment to the service provider.

32. The computer readable storage medium of claim 31, the one or more programs further comprising instructions for:
when the service provider has an available timeslot within a predetermined period of time from a current time, offering a discount to the user; and
prior to accepting the payment from the user, applying the discount to the invoice.

33. The computer readable storage medium of claim 27, the one or more programs further comprising instructions for:
after the appointment, providing an invoice for the appointment to the user;
accepting payment from the user for the invoice; and
sending at least a portion of the payment to the service provider.

34. The computer readable storage medium of claim 27, the one or more programs further comprising instructions for:
when the service provider has an available timeslot that meets discount criteria, visually distinguishing the timeslot meeting the discount criteria on the calendar view.

35. The computer readable storage medium of claim 27, the one or more programs further comprising instructions for:
receiving appointment constraints from the service provider, and
determining that the appointment request can be accepted in accordance with the received appointment constraints, wherein the appointment constraints include one or more of the following:
appointment duration;
specified users allowed to book appointments;
specified users not allowed to book appointments;
a number of seats available for a set appointment time;
a number of concurrently available appointments; and
appointment location.

36. The computer readable storage medium of claim 27, wherein the instructions for booking the appointment comprise instructions for automatically updating the calendar view of the service provider.

37. The computer readable storage medium of claim 36, wherein the instructions for booking the appointment comprise instructions for automatically adding the appointment to another calendar view of the user, the another calendar view being distinct from the calendar view.

38. The computer readable storage medium of claim 27, the one or more programs further comprising:
prior to booking, allowing the service provider to accept or deny the appointment.

39. The method of claim 1, wherein the first view of the first calendar shows the available time slots for multiple different services provided by the service provider.
